(19) United States
(12) Patent Application Publication
(10) Pub. No.: US 2025/0110335 A1
(43) Pub. Date: Apr. 3, 2025

(54) HEAD-UP DISPLAY

(71) Applicant: Japan Display Inc., Tokyo (JP)

(72) Inventors: Kazunari TOMIZAWA, Tokyo (JP); Chikyu NAKAOKA, Tokyo (JP); Takeo KOITO, Tokyo (JP)

(21) Appl. No.: 18/899,315

(22) Filed: Sep. 27, 2024

(30) Foreign Application Priority Data
Oct. 2, 2023 (JP) 2023-171522

(51) Int. Cl. G02B 27/01

(52) U.S. Cl. CPC G02B 27/0101

(57) ABSTRACT

According to an aspect, a head-up display causes an image reflected by a light transmitting member to be superimposed on a real image transmitted by the light transmitting member and causes the superimposed image to be visually recognized as a virtual image by an viewer. The head-up display includes a display device and a magnification optical system. The display device includes a backlight, a first image display panel that receives direct light from the backlight, and a second image display panel that is disposed with a gap between the second image display panel and the first image display panel and receives light transmitted by the first image display panel. The first image display panel includes a first polarizer provided between the first image display panel and the backlight. The second image display panel includes a second polarizer provided between the second image display panel and the magnification optical system.

### CROSS-REFERENCE TO RELATED APPLICATION

This application claims the benefit of priority from Japanese Patent Application No. 2023-171522 filed on Oct. 2, 2023, the entire contents of which are incorporated herein by reference.

### BACKGROUND

### 1. Technical Field

What is disclosed herein relates to a head-up display.

### 2. Description of the Related Art

A head-up display (HUD) is known that projects an image onto a light transmitting member, such as glass, to allow the image reflected by the light transmitting member to be visually recognized as a virtual image by a viewer (e.g., Japanese Patent Application Laid-open Publication No. 2004-168230 (JP-A-2004-168230)).

In such a HUD, the spatial position of the virtual image visually recognized by the viewer depends on the relative positions between a display panel, a reflection member, and a viewpoint of the viewer. Specifically, as the distance between the display panel and the reflection member increases, the distance from the viewpoint of the viewer to the virtual image increases; and as the distance between the display panel and the reflection member decreases, the distance from the viewpoint of the viewer to the virtual image decreases. In the head-up display disclosed in JP-A-2004-168230, a plurality of display panels are placed vertically with a gap interposed therebetween, and the display panels display different output images, whereby the distances from the viewpoint of the viewer to the virtual images of the respective output images displayed by the display panels are different from one another.

In the above conventional technique, the display regions of the display panels are arranged such that they are not superimposed on each other in a sight line direction of the viewer. Thus, images at different distances from the viewpoint of the viewer to the virtual images may fail to be freely arranged at the viewpoint of the viewer.

For the foregoing reasons, there is a need for a head-up display that can increase a degree of flexibility in arranging images at different distances from the viewpoint of the viewer to the virtual images.

### SUMMARY

According to an aspect, a head-up display causes an image reflected by a light transmitting member that transmits and reflects incident light to be superimposed on a real image transmitted by the light transmitting member and causes the superimposed image to be visually recognized as a virtual image by a viewer. The head-up display includes: a display device that displays an image; and a magnification optical system that magnifies the image displayed on the display device and projects the magnified image onto the light transmitting member. The display device includes a backlight, a first image display panel that receives direct light from the backlight, and a second image display panel that is disposed with a gap between the second image display panel and the first image display panel and receives light transmitted by the first image display panel. The first image display panel includes a first polarizer provided between the first image display panel and the backlight. The second image display panel includes a second polarizer provided between the second image display panel and the magnification optical system. The first polarizer transmits light polarized in a first direction and blocks light polarized in a direction different from the first direction. The second polarizer transmits light polarized in a second direction different from the first direction and blocks light polarized in a direction different from the second direction. No other polarizer is provided between the first image display panel and the second image display panel.

### BRIEF DESCRIPTION OF THE DRAWINGS

FIG. 1 is a schematic diagram illustrating a schematic configuration of a head-up display (HUD) according to a first embodiment;

FIG. 2A is a schematic diagram illustrating a basic configuration of the HUD;

FIG. 2B is a schematic diagram illustrating an equivalent configuration of the HUD illustrated in FIG. 2A;

FIG. 3 is a graph illustrating a relation between a distance between a panel and a lens, and a virtual distance between a viewpoint and a virtual image;

FIG. 4 is a schematic diagram illustrating the equivalent configuration of the HUD according to the first embodiment;

FIG. 5 is a schematic diagram illustrating a detailed configuration of a display device according to the first embodiment;

FIG. 6A is a diagram illustrating a first example of a display mode of the HUD according to the first embodiment;

FIG. 6B is a diagram illustrating a first object visually recognized in the virtual image of a first image in the display mode illustrated in FIG. 6A;

FIG. 6C is a diagram illustrating a second object visually recognized in the virtual image of a second image in the display mode illustrated in FIG. 6A;

FIG. 6D is an A-A line cross sectional view of the display device according to the first embodiment illustrated in FIG. 6A;

FIG. 7A is a diagram illustrating a second example of the display mode of the HUD according to the first embodiment;

FIG. 7B is a diagram illustrating the first object visually recognized in the virtual image of the first image in the display mode illustrated in FIG. 7A;

FIG. 7C is a diagram illustrating the second object visually recognized in the virtual image of the second image in the display mode illustrated in FIG. 7A;

FIG. 7D is the A-A line cross sectional view of the display device according to the first embodiment illustrated in FIG. 7A;

FIG. 8 is a schematic diagram illustrating a schematic configuration of a HUD according to a second embodiment;

FIG. 9 is a schematic diagram illustrating a detailed configuration of a display device according to the second embodiment;

FIG. 10A is a diagram illustrating an example of the display mode of the HUD according to the second embodiment;

FIG. 10B is a diagram illustrating the first object visually recognized in the virtual image of the first image in the display mode illustrated in FIG. 10A;

FIG. 10C is a diagram illustrating the second object visually recognized in the virtual image of the second image in the display mode illustrated in FIG. 10A;

FIG. 10D is the A-A line cross sectional view of the display device according to the second embodiment illustrated in FIG. 10A;

FIG. 11 is a schematic diagram illustrating a path of incoming sunlight in the HUD according to the second embodiment;

FIG. 12 is a schematic diagram illustrating the path of incoming sunlight in a HUD according to a third embodiment;

FIG. 13 is a schematic diagram illustrating the schematic configuration of the HUD according to the third embodiment;

FIG. 14 is a schematic diagram illustrating the path of incoming sunlight in a HUD according to a modification of the third embodiment;

FIG. 15 is a schematic diagram illustrating the schematic configuration of the HUD according to the modification of the third embodiment;

FIG. 16A is a schematic diagram illustrating a first example of the detailed configuration of a display device according to a fourth embodiment;

FIG. 16B is a schematic diagram illustrating a second example of the detailed configuration of the display device according to the fourth embodiment; and

FIG. 16C is a schematic diagram illustrating a third example of the detailed configuration of the display device according to the fourth embodiment.

### DETAILED DESCRIPTION

The following describes embodiments of the present disclosure in detail with reference to the accompanying drawings. The present disclosure is not limited to the descriptions of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

### First Embodiment

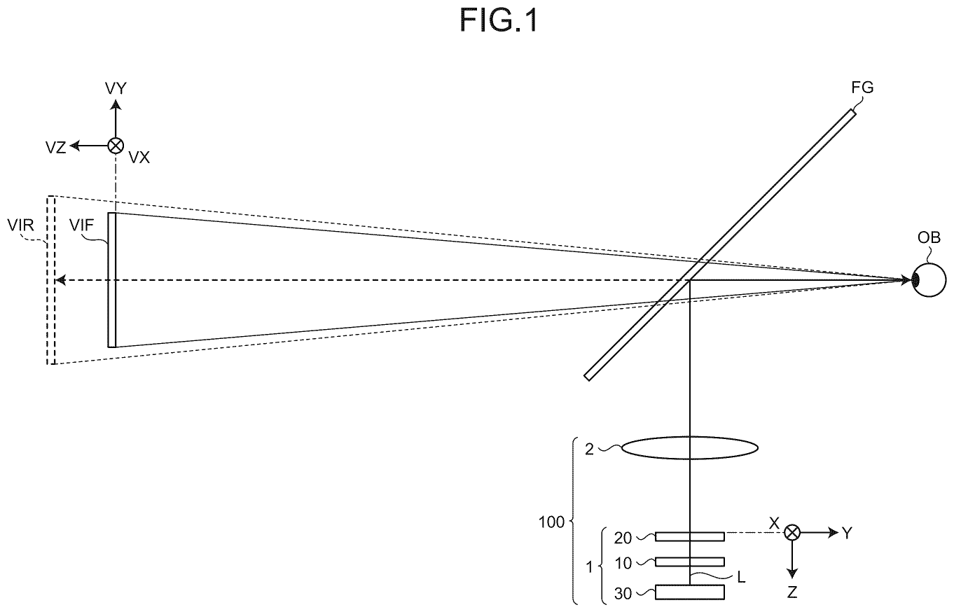

FIG. 1 is a schematic diagram illustrating a schematic configuration of a head-up display according to a first embodiment. This head-up display (referred to simply as “HUD”) 100 includes a display device 1 that displays images and a magnification optical system 2 that magnifies the images displayed on the display device 1 and projects them onto a light transmitting member FG.

The light transmitting member FG is a member having a light transmitting property such as glass or resin. Examples of the light transmitting member FG include vehicle windshields and combiners. The light transmitting member FG can be any member that transmits and reflects incident light and is not limited to the vehicle windshield or the combiner.

An example of the magnification optical system 2 is a lens. The magnification optical system 2 is not limited to the example. The magnification optical system 2 may be composed of a plurality of optical members, such as plane mirrors and concave mirrors, for example.

The display device 1 according to the first embodiment includes, as major components, a first image display panel 10 that displays a first image, a second image display panel 20 that displays a second image, and a backlight 30.

The backlight 30 emits planar light (light L) toward the first image display panel 10. The light L emitted from the backlight 30 is transmitted through the first image display panel 10, the second image display panel 20, and the magnification optical system 2 in this order, as illustrated with the solid arrow in FIG. 1, and is reflected by the light transmitting member FG to reach a viewpoint of an observer (viewer) OB. An image output region of the first image display panel 10 and an image output region of the second image display panel 20 are superimposed on each other in an optical axis direction of the magnification optical system. As a result, a virtual image VIR of the first image reflected by the light transmitting member FG and a virtual image VIF of the second image reflected by the light transmitting member FG are superimposed on each other in the sight line direction indicated with the dashed arrow in FIG. 1, and are visually recognized by the viewer OB.

In the following description, a virtual distance from the viewpoint of the viewer OB to the virtual image VIR of the first image reflected by the light transmitting member FG and to the virtual image VIF of the second image reflected by the light transmitting member FG is also referred to simply as the “virtual distance”. A virtual position of each of the virtual image VIR of the first image reflected by the light transmitting member FG and the virtual image VIF of the second image reflected by the light transmitting member FG is also referred to simply as the “virtual position”.

In the present disclosure, an “optical axis of the magnification optical system” does not indicate the individual optical axis of each optical member when the magnification optical system 2 is composed of multiple optical members, but indicates the optical axis that passes through the magnification optical system 2 composed of the multiple optical members and enters the second image display panel 20.

In the schematic configuration of the HUD 100 according to the first embodiment illustrated in FIG. 1, the first image display panel 10 and the second image display panel 20 are arranged substantially parallel to a plane (X-Y plane) perpendicular to the optical axis of the magnification optical system 2. As a result, the virtual image VIR of the first image and the virtual image VIF of the second image to be visually recognized by the viewer OB are visually recognized, by the viewer OB, on the virtual plane (VX-VY plane) that is substantially parallel to the sight line direction of the viewer OB. The sight line direction is illustrated with the dashed arrow in FIG. 1.

In the schematic configuration of the HUD 100 according to the first embodiment illustrated in FIG. 1, the first image display panel 10 is disposed farther from the magnification optical system 2 than the second image display panel 20 in the direction of the optical axis of the magnification optical system 2, in other words, in the Z direction orthogonal to the X-Y plane perpendicular to the optical axis of the magnification optical system 2. As a result, the virtual image VIR of the first image displayed on the first image display panel 10 is visually recognized by the viewer OB at a virtual position farther away from the virtual image VIF of the second image displayed on the second image display panel 20 in the VZ direction orthogonal to the VX-VY plane. In other words, the virtual distance from the viewpoint of the viewer OB to the virtual image VIR of the first image is larger than the virtual distance from the viewpoint of the viewer OB to the viewpoint VIF of the second image. The virtual image VIR of the first image displayed on the first image display panel 10 is visually recognized by the viewer OB such that the virtual image VIR is superimposed on the virtual image VIF of the second image displayed on the second image display panel 20. In such a virtual image optical system, in a case where the first image displayed on the first image display panel 10 and the second image displayed on the second image display panel 20 have the same size and the same shape, the virtual image VIR of the first image visually recognized by the viewer OB is larger than the virtual image VIF of the second image when visually recognized by the viewer OB.

The following describes a relative positional relation between the virtual images VIR and VIF visually recognized by the viewer OB in the HUD 100 according to the first embodiment.

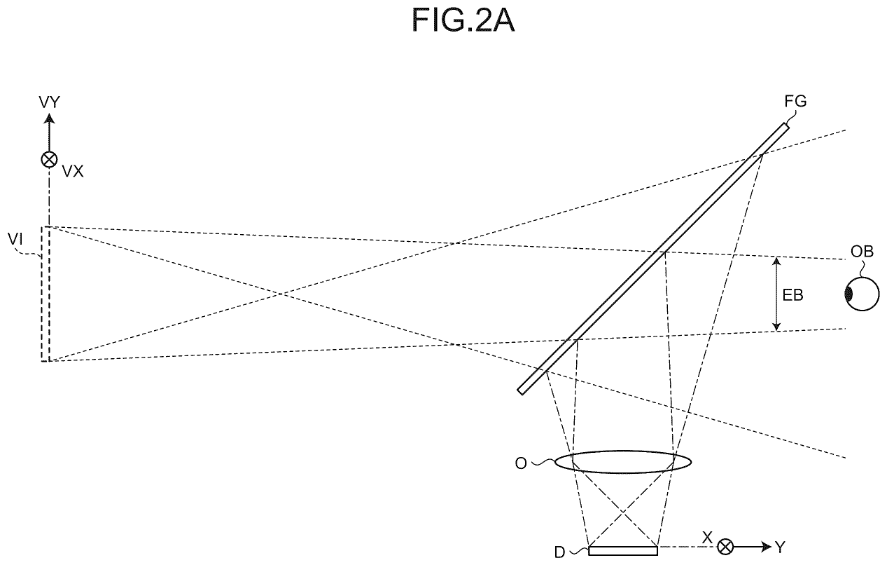

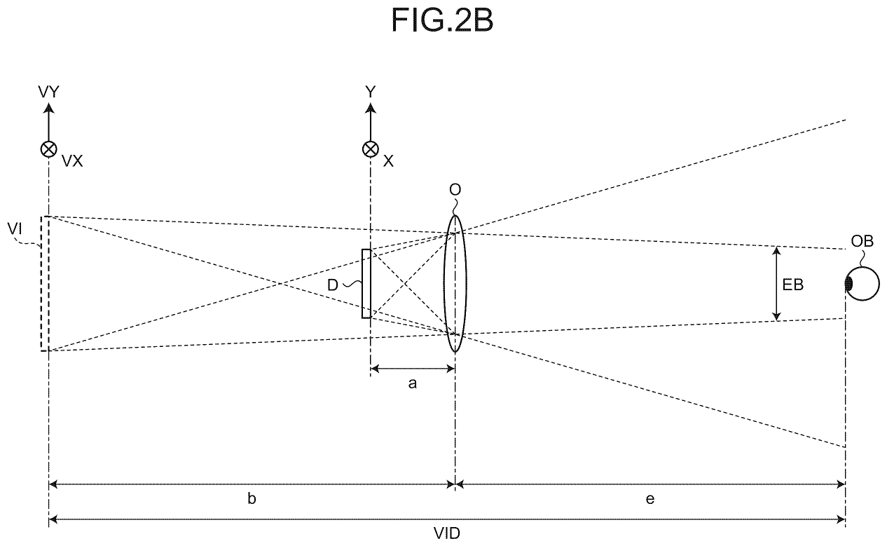

FIG. 2A is a schematic diagram illustrating a basic configuration of the HUD. FIG. 2B is a schematic diagram illustrating an equivalent configuration of the HUD illustrated in FIG. 2A.

The eye box EB illustrated in FIG. 2A indicates the range in which the viewer OB can visually recognize the virtual image VI. As illustrated in FIG. 2B, when the lens O and the image display panel D that are included in the HUD illustrated in FIG. 2A are aligned in the sight line direction of the viewer OB, the distance “a” (mm), the virtual distance “b” (mm), and a focal distance “f” (mm) of the lens O have a relation expressed by the following Expression (1). The distance “a” (mm) is a distance from the image display panel D to the center line of the lens O. The virtual distance “b” (mm) is a distance from the virtual image VI to the center line of the lens O. The distance “a” from the image display panel D to the centerline of the lens O is less than the focal distance “f” of the lens O (f>a).

$$\frac{1}{a} - \frac{1}{b} = \frac{1}{f} \qquad ( 1 )$$

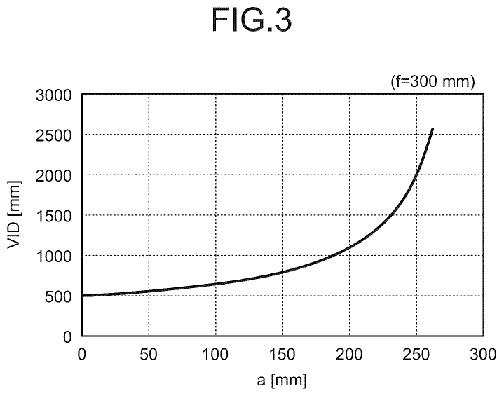

The virtual distance VID (mm) from the viewpoint of the viewer OB to the virtual image VI is expressed by the following Expression (2) using the distance “e”. The distance “e” is a distance from the centerline of the lens O to the viewpoint of the viewer OB. FIG. 3 is a graph illustrating a relation between the distance “a” between the panel and the lens, and the virtual distance VID between the viewpoint and the virtual image.

$$VID = b + e = \frac{fa}{f - a} + e \qquad ( 2 )$$

As expressed in Expression (2) and FIG. 3, as the distance “a” from the image display panel D to the centerline of the lens O increases, the virtual distance VID from the viewpoint of the viewer OB to the virtual image VI increases. As the distance “a” from the image display panel D to the centerline of the lens O comes closer to the focal distance “f”, the change amount of the virtual distance VID from the viewpoint of the viewer OB to the virtual image VI with respect to the change in the distance “a” increases.

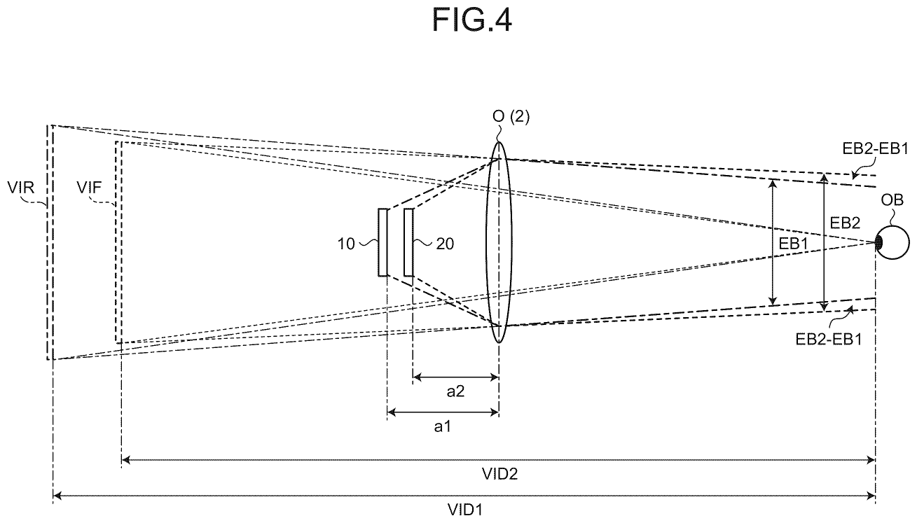

FIG. 4 is a schematic diagram illustrating the equivalent configuration of the HUD according to the first embodiment. As described above, in the schematic configuration of the HUD 100 according to the first embodiment illustrated in FIG. 1, the first image display panel 10 is disposed farther from the magnification optical system 2 than the second image display panel 20 in the direction of the optical axis of the magnification optical system 2, in other words, in the direction (the Z direction) orthogonal to the X-Y plane perpendicular to the optical axis of the magnification optical system 2.

Specifically, in the equivalent configuration of the HUD 100 according to the first embodiment illustrated in FIG. 4, the distance a1 from the first image display panel 10 to the centerline of the lens O (the magnification optical system 2) is larger than the distance a2 from the second image display panel 20 to the centerline of the lens O (the magnification optical system 2) (a1>a2).

The virtual distance VID1 from the viewpoint of the viewer OB to the virtual image VIR of the first image displayed on the first image display panel 10 corresponds to the distance a1 from the first image display panel 10 to the centerline of the lens O (the magnification optical system 2). The virtual distance VID2 from the viewpoint of the viewer OB to the virtual image VIF of the second image displayed on the second image display panel 20 corresponds to the distance a2 from the second image display panel 20 to the center line of the lens O (the magnification optical system 2). Therefore, in the equivalent configuration of the HUD 100 according to the first embodiment illustrated in FIG. 4, the virtual distance VID1 from the viewpoint of the viewer OB to the virtual image VIR of the first image displayed on the first image display panel 10 is larger than the virtual distance VID2 from the viewpoint of the viewer OB to the virtual image VIF of the second image displayed on the second image display panel 20 (VID1>VID2).

As a result, the virtual image VIR of the first image displayed on the first image display panel 10 is visually recognized at a virtual position farther from the viewer OB than the virtual image VIF of the second image displayed on the second image display panel 20.

In the present disclosure, the image output region of the first image display panel 10 and the image output region of the second image display panel 20 are superimposed on each other in the optical axis direction of the magnification optical system 2, as described above, and the virtual image VIR of the first image reflected by the light transmitting member FG and the virtual image VIF of the second image reflected by the light transmitting member FG are visually recognized in such a state that they are superimposed on each other in the sight line direction of the viewer OB. In such a mode, the display device 1 according to the present disclosure can cause each of a first object in the virtual image VIR of the first image and a second object in the virtual image VIF of the second image to be disposed at a desired position in the region in which the virtual image VIR of the first image and the virtual image VIF of the second image are superimposed on each other in the sight line direction of the viewer OB. The following describes the detailed configuration of the display device 1 that enables the display mode described above.

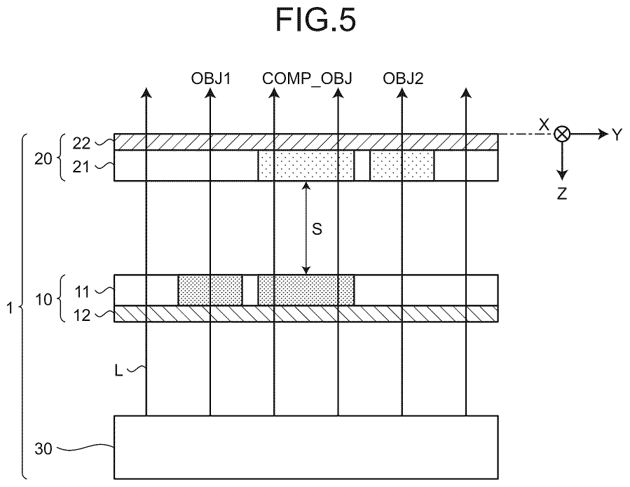

FIG. 5 is a schematic diagram illustrating the detailed configuration of the display device according to the first embodiment.

Direct light from the backlight 30 enters the first image display panel 10.

The second image display panel 20 is disposed with a gap S between the second image display panel 20 and the first image display panel 10. Light transmitted by the first image display panel 10 enters the second image display panel 20.

In the display device 1 according to the first embodiment, the first image display panel 10 includes a first liquid crystal panel 11 and a first polarizer 12. The first polarizer 12 is provided on the surface of the first liquid crystal panel 11 on the backlight 30 side thereof.

In the display device 1 according to the first embodiment, the second image display panel 20 includes a second liquid crystal panel 21 and a second polarizer 22. The second polarizer 22 is provided on the surface of the second liquid crystal panel 21 on the magnification optical system 2 side thereof.

The first liquid crystal panel 11 and the second liquid crystal panel 21 are transmissive liquid crystal display panels. They have a plurality of pixels driven by an active matrix method, for example. The pixels are two-dimensionally arranged along the plate surfaces of the first and the second liquid crystal panels 11 and 21. In each of the image output regions (not illustrated) in which the pixels are arranged, the pixels are individually controlled to form a light transmission pattern corresponding to the virtual image VIR of the first image or the virtual image VIF of the second image. As a result, when incident light passes through the image output region of the first liquid crystal panel 11, the light quantity is adjusted according to the gradation values of the pixels provided at the positions corresponding to a first object OBJ1 in the virtual image VIR of the first image and is emitted as transmitted light. When the incident light passes through the image output region of the second liquid crystal panel 21, the light quantity is adjusted according to the gradation values of the pixels at the positions corresponding to a second object OBJ2 in the virtual image VIF of the second image and is emitted as transmitted light.

The first polarizer 12 and the second polarizer 22 are arranged in a state where their transmission axes are orthogonal to each other with respect to the incident light (cross-Nicol arrangement). In the display device 1 according to the present disclosure, no polarizer is provided between the first image display panel 10 and the second image display panel 20.

The first polarizer 12 is an optical member that transmits light polarized in a first direction and blocks light polarized in a direction different from the first direction. Specifically, the first polarizer 12 is a linear polarizer with a transmission axis in the Y direction, for example.

The second polarizer 22 is an optical member that transmits light polarized in a second direction different from the first direction and blocks light polarized in a direction different from the second direction.

Specifically, the second polarizer 22 is a linear polarizer with a transmission axis in the X direction, for example.

In the configuration of the display device 1 according to the first embodiment described above, the gradation value at the position in the virtual image visually recognized from the viewpoint of the viewer OB is expressed by the following Expression (3), using the gradation value R at the corresponding position in the image output region of the first liquid crystal panel 11 and the gradation value F at the corresponding position in the image output region of the second liquid crystal panel 21. In Expression (3), the gradation value R and the gradation value F are normalized with the maximum value set to 1. The initial orientation and direction of rotation of the liquid crystal molecules of the first and the second liquid crystal panels 11 and 21 are determined so as to satisfy Expression (3).

$$A = R + F - 2 \times R \times F \qquad ( 3 )$$

For example, when the gradation value R at the position corresponding to the first object OBJ1 in the virtual image VIR of the first image is 0.8 (R=0.8) and the gradation value F is 0 (F=0), the gradation value A of the first object OBJ1 visually recognized by the viewer OB is 0.8 (A=0.8).

For example, when the gradation value R at the position corresponding to the second object OBJ2 in the virtual image VIF of the second image is 0 (R=0) and the gradation value F is 0.4 (F=0.4), the gradation value A of the second object OBJ2 visually recognized by the viewer OB is 0.4 (A=0.4).

Furthermore, for example, in the display mode in which the first object OBJ1 in the virtual image VIR of the first image and the second object OBJ2 in the virtual image VIF of the second image are superimposed on each other in the sight line direction of the viewer OB to form a composite object COMP_OBJ (the display mode is described later), when the gradation value R at the position corresponding to the composite object COMP_OBJ is 0.8 (R=0.8) and the gradation value F is 0.4 (F=0.4), the gradation value A of the composite object COMP_OBJ visually recognized by the viewer OB is 0.56 (A=0.56).

When the composite object COMP_OBJ is visually recognized by the viewer OB, the first object OBJ1 in the virtual image VIR of the first image is smaller than the second object OBJ2 in the virtual image VIF of the second image. When the viewpoint of the viewer OB is shifted, the first object OBJ1 in the virtual image VIR of the first image and the second object OBJ2 in the virtual image VIF of the second image may be visually recognized by the viewer OB as being out of alignment, causing visual discomfort for the viewer OB.

In the configuration of the present disclosure that causes the viewer to visually recognize the virtual image VIR of the first image and the virtual image VIF of the second image, the region in which the first object OBJ1 and the second object OBJ2 are visually recognized as being out of alignment by the viewer OB is limited to a region EB2−EB1. In the region EB2−EB1, an eye box EB1 that allows the virtual image VIR of the first image to be visually recognized and an eye box EB2 that allows the virtual image VIF of the second image to be visually recognized do not overlap (refer to FIG. 4).

The following describes specific examples of the display mode of the HUD 100 according to the first embodiment.

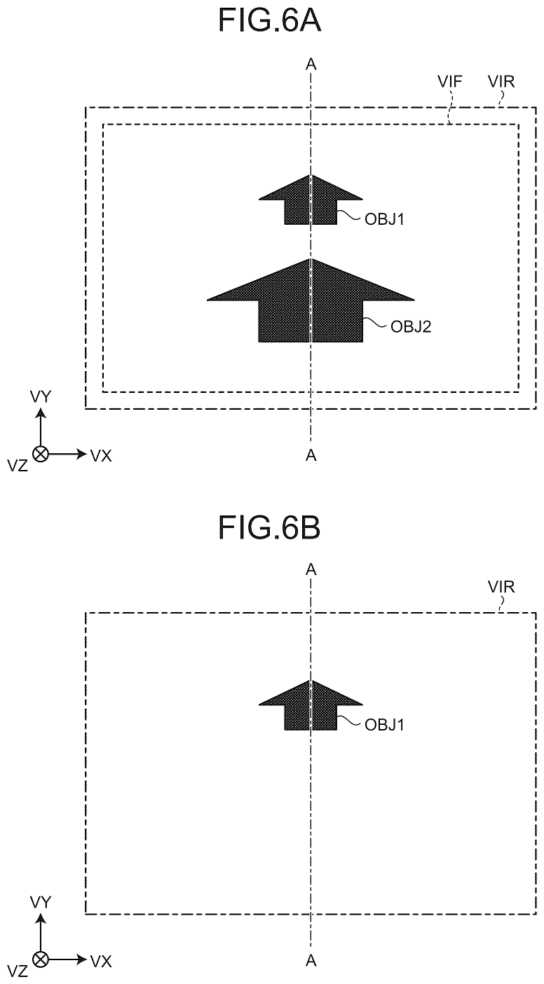

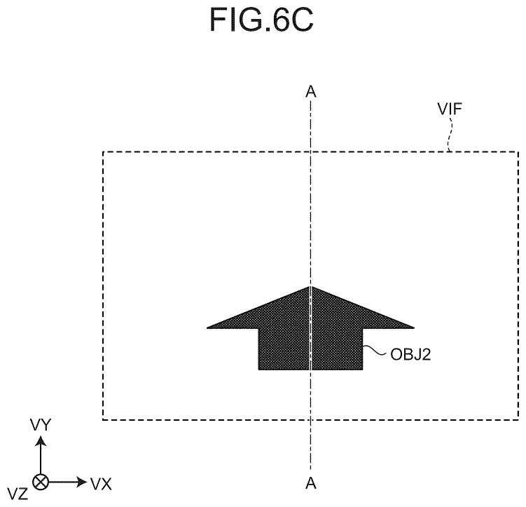

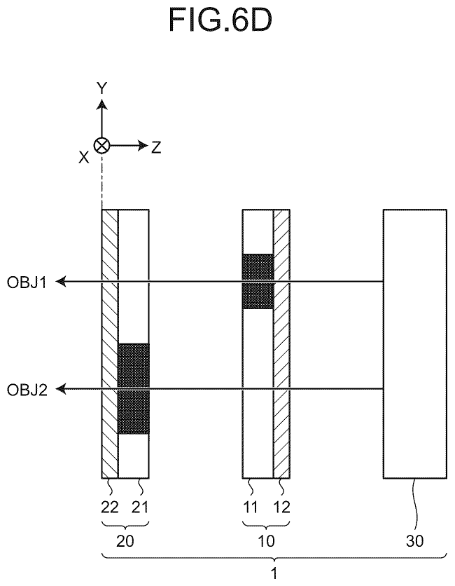

FIG. 6A is a diagram illustrating a first example of the display mode of the HUD according to the first embodiment. FIG. 6B is a diagram illustrating the first object visually recognized in the virtual image of the first image in the display mode illustrated in FIG. 6A. FIG. 6C is a diagram illustrating the second object visually recognized in the virtual image of the second image in the display mode illustrated in FIG. 6A. FIG. 6D is an A-A line cross sectional view of the display device according to the first embodiment illustrated in FIG. 6A.

In the display mode illustrated in FIG. 6A, the first object OBJ1 is disposed in a relatively upper part and the second object OBJ2 is disposed in a relatively lower part in the region in which the virtual image VIR of the first image and the virtual image VIF of the second image are superimposed on each other in the sight line direction of the viewer OB.

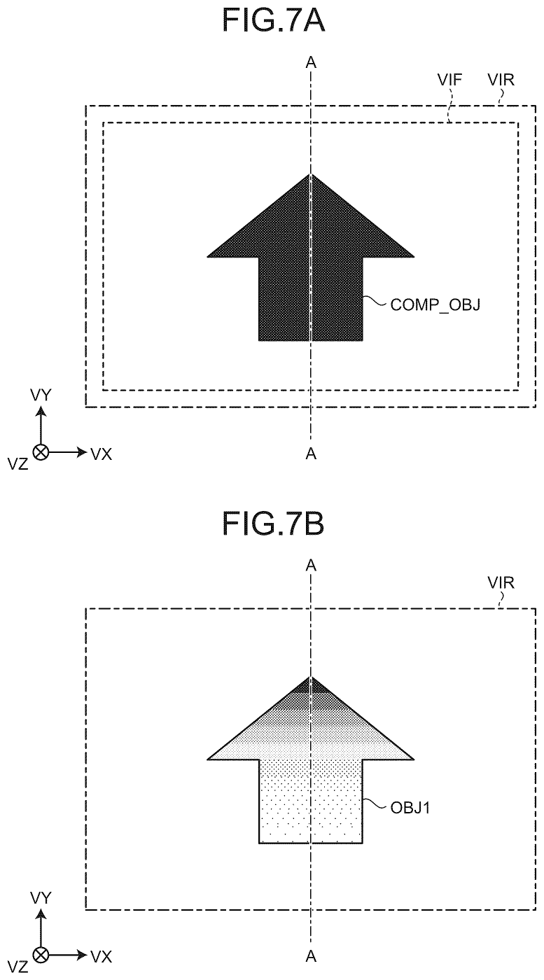

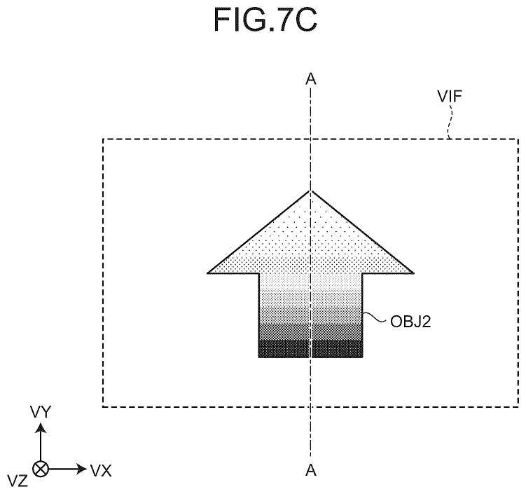

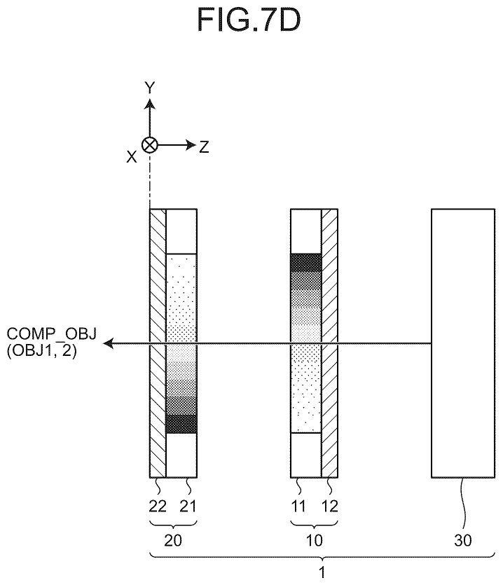

FIG. 7A is a diagram illustrating a second example of the display mode of the HUD according to the first embodiment. FIG. 7B is a diagram illustrating the first object visually recognized in the virtual image of the first image in the display mode illustrated in FIG. 7A. FIG. 7C is a diagram illustrating the second object visually recognized in the virtual image of the second image in the display mode illustrated in FIG. 7A. FIG. 7D is the A-A line cross sectional view of the display device according to the first embodiment illustrated in FIG. 7A.

In the display mode illustrated in FIG. 7A, the first object OBJ1 in the virtual image VIR of the first image and the second object OBJ2 in the virtual image VIF of the second image are superimposed on each other in the sight line direction of the viewer OB to form the composite object COMP_OBJ. In the VY direction in the region in which the virtual image VIR of the first image and the virtual image VIF of the second image are superimposed on each other at the viewpoint of the viewer OB in the sight line direction of the viewer OB, as the gradation value of the second object OBJ2 increases, the gradation value of the first object OBJ1 decreases. As a result, the composite object COMP_OBJ, which gives the illusion that it is tilted from front to back in the direction from bottom to top, is visually recognized by the viewer OB in the region in which the virtual image VIR of the first image and the virtual image VIF of the second image are superimposed on each other at the viewpoint of the viewer OB in the sight line direction of the viewer OB.

In this way, the HUD 100 according to the first embodiment can freely dispose the first object in the virtual image VIR of the first image and the second object in the virtual image VIF of the second image in the region in which the virtual image VIR of the first image and the virtual image VIF of the second image are visually observed by the viewer OB as being superimposed on each other in the sight line direction of the viewer OB.

In the display mode in which the first object OBJ1 in the virtual image VIR of the first image and the second object OBJ2 in the virtual image VIF of the second image are superimposed on each other in the sight line direction of the viewer OB to form the composite object COMP_OBJ, control is performed such that as the gradation value of the first object OBJ1 increases, the gradation value of the second object OBJ2 decreases at least in one direction in the region in which the virtual image VIR of the first image and the virtual image VIF of the second image are superimposed on each other in the sight line direction of the viewer OB. This makes it possible to cause the viewer OB to visually recognize as if the composite object COMP_OBJ is tilted in one direction.

### Second Embodiment

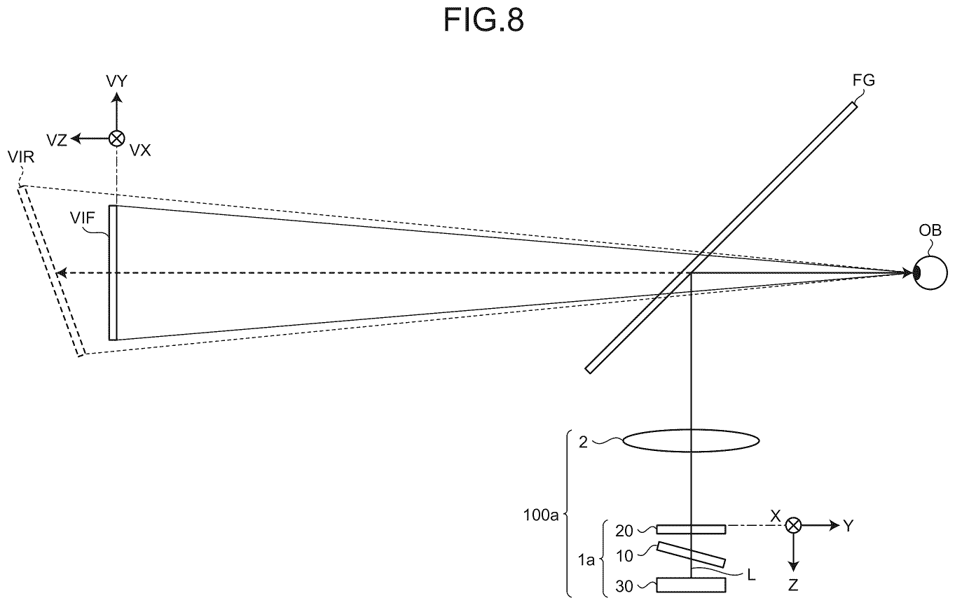

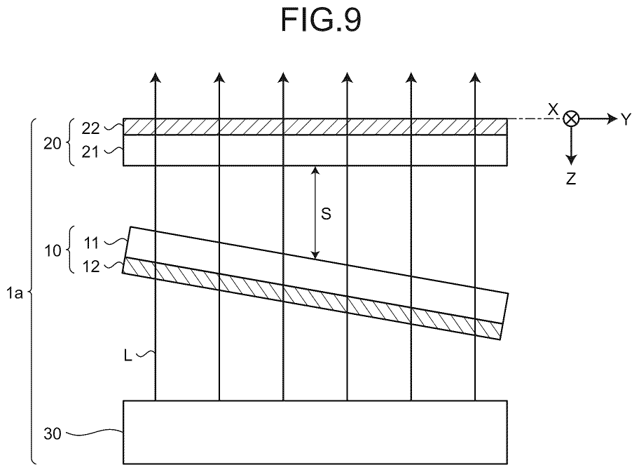

FIG. 8 is a schematic diagram illustrating a schematic configuration of a HUD according to a second embodiment. FIG. 9 is a schematic diagram illustrating a detailed configuration of a display device according to the second embodiment. The configuration and operations that differ from those of the first embodiment are described, and duplicate explanations may be omitted.

In a display device 1a of a HUD 100a according to the second embodiment, the first image display panel 10 is disposed tilted with respect to the second image display panel 20. The second image display panel 20 is disposed substantially parallel to the X-Y plane perpendicular to the optical axis of the magnification optical system 2. The tilt angle of the first image display panel 10 with respect to the second image display panel 20 (the X-Y plane perpendicular to the optical axis of the magnification optical system 2) is about 40 degrees, for example. As a result, the virtual image VIR of the first image displayed on the first image display panel 10 is visually recognized by the viewer OB as being tilted with respect to the virtual image VIF of the second image displayed on the second image display panel 20.

More specifically, in the schematic configuration of the HUD 100a according to the second embodiment illustrated in FIG. 8, the virtual image VIR of the first image is visually recognized as being tilted from front to back in the direction from bottom to top at the viewpoint of the viewer OB.

The following describes specific examples of the display mode of the HUD 100a according to the second embodiment.

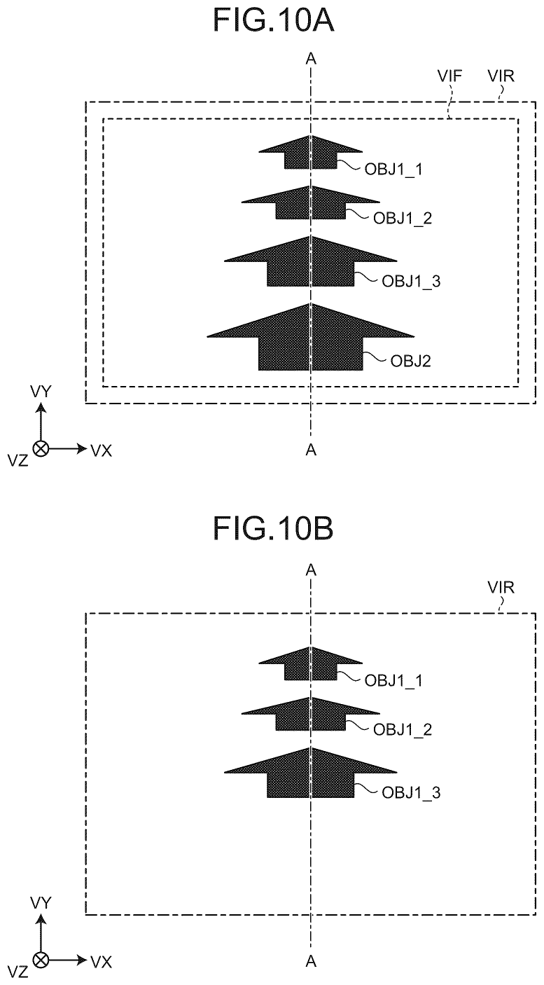

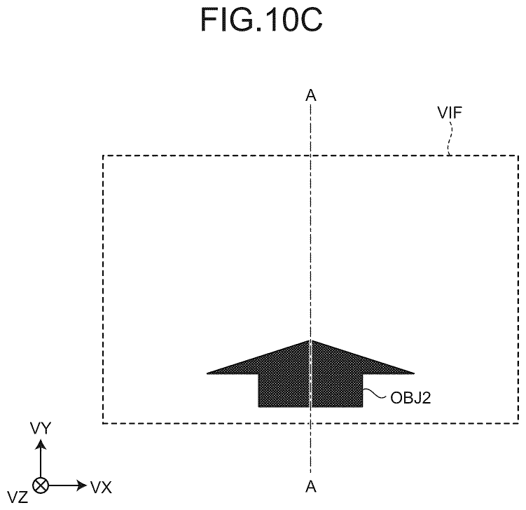

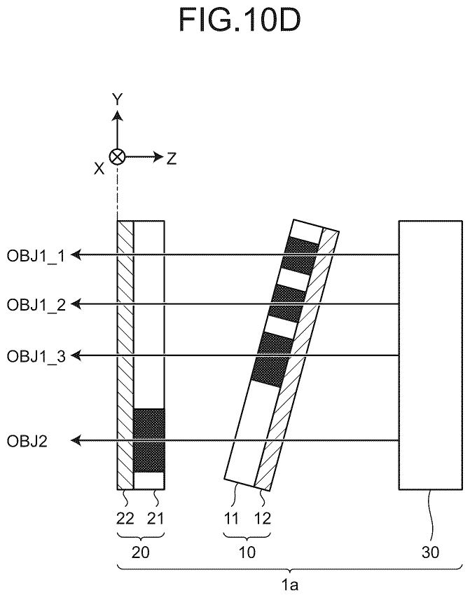

FIG. 10A is a diagram illustrating an example of the display mode of the HUD according to the second embodiment. FIG. 10B is a diagram illustrating the first object visually recognized in the virtual image of the first image in the display mode illustrated in FIG. 10A. FIG. 10C is a diagram illustrating the second object visually recognized in the virtual image of the second image in the display mode illustrated in FIG. 10A. FIG. 10D is the A-A line cross sectional view of the display device according to the second embodiment illustrated in FIG. 10A.

In the display mode illustrated in FIG. 10A, the first objects OBJ1_1, OBJ1_2, and OBJ1_3 are visually recognized in a relatively upper part and the second object OBJ2 is visually recognized in a relatively lower part in the region in which the virtual image VIR of the first image and the virtual image VIF of the second image are superimposed on each other in the sight line direction of the viewer OB. The first objects OBJ1_1, OBJ1_2, and OBJ1_3, which are visually recognized in the virtual image VIR of the first image, are visually recognized as being arranged from front to back in the order of the first objects OBJ1_3, OBJ1_2, and OBJ1_1.

In order to achieve such a display mode, the first image display panel 10 is disposed in such a tilted state that a gap S between the first image display panel 10 and the second image display panel 20 is large at the upper end in the Y direction and the gap S is small at the lower end in the Y direction, relative to the X-Y plane that is substantially parallel to the second image display panel 20 (refer to FIG. 10D).

In this way, the HUD 100a according to the second embodiment makes it possible to cause the viewer OB to visually recognize that the virtual image VIR of the first image is tilted with the virtual image VIF of the second image in the region in which the virtual image VIR of the first image and the virtual image VIF of the second image are visually recognized as being superimposed on each other in the sight line direction of the viewer OB.

As described above, the first image display panel 10 is disposed in such a tilted state that the gap S between the first image display panel 10 and the second image display panel 20 is large at the upper end in the Y direction and the gap S is small at the lower end in the Y direction, relative to the X-Y plane that is substantially parallel to the second image display panel 20. This configuration makes it possible to cause the virtual image VIR of the first image to be visually recognized as being tilted from front to back in the direction from bottom to top at the viewpoint of the viewer OB.

### Third Embodiment

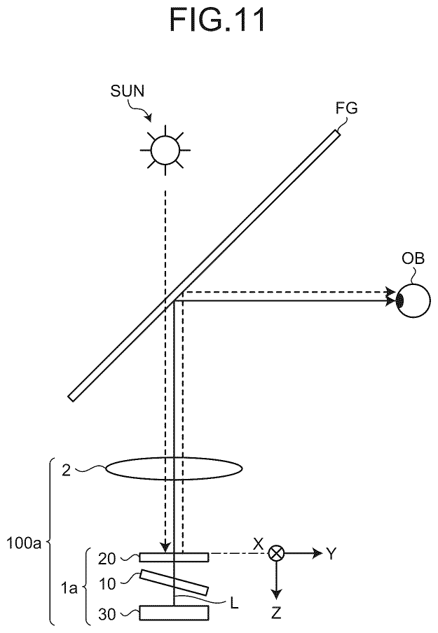

FIG. 11 is a schematic diagram illustrating a path of incoming sunlight in the HUD in which the second image display panel is disposed substantially parallel to the X-Y plane. The X-Y plane illustrated in FIG. 11 is perpendicular to the optical axis of the magnification optical system 2. FIG. 11 exemplarily illustrates the HUD according to the second embodiment as an example of the configuration in which the second image display panel is disposed substantially parallel to the X-Y plane, and the path of incoming sunlight is illustrated with the dashed arrow.

Sunlight entering the display device (e.g., the display device 1a according to the second embodiment) in the optical axis direction of the magnification optical system 2 is reflected by the surface of the second image display panel 20 (more specifically, the surface of the second polarizer 22). In the HUD in which the second image display panel 20 is disposed substantially parallel to the X-Y plane perpendicular to the optical axis of the magnification optical system 2 (e.g., the HUD 100a according to the second embodiment), sunlight reflected on the surface of the second image display panel 20 (the surface of the second polarizer 22) may travel along the optical axis of the magnification optical system 2 and be reflected by the light transmitting member FG and enter the eyes of the viewer OB.

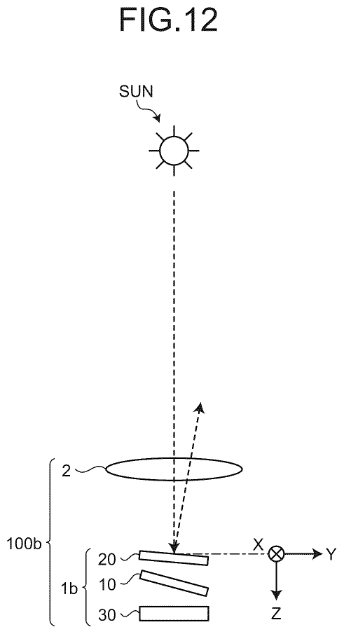

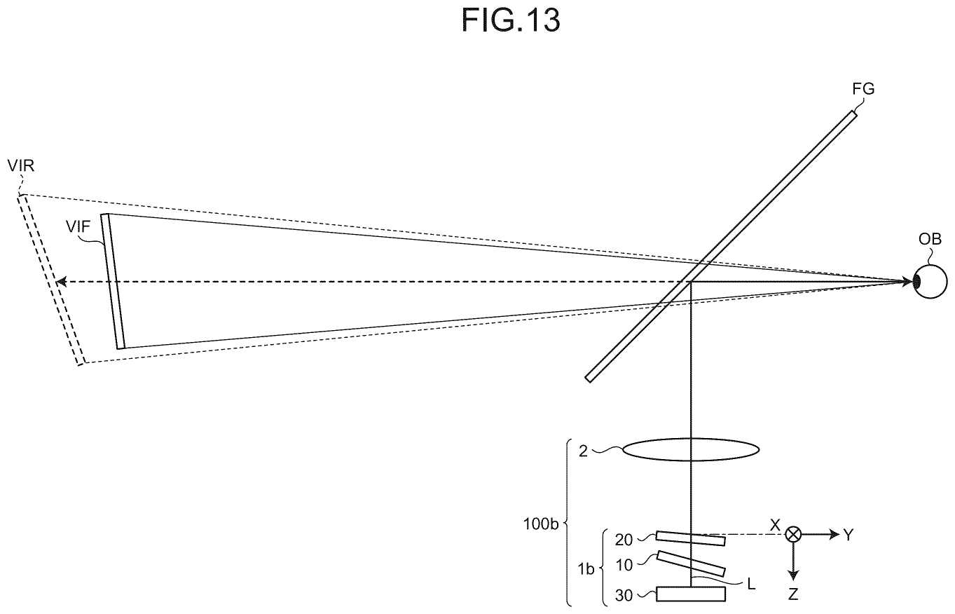

FIG. 12 is a schematic diagram illustrating the path of incoming sunlight in a HUD according to a third embodiment. FIG. 13 is a schematic diagram illustrating a schematic configuration of the HUD according to the third embodiment. The configurations and operations that differ from those of the first and the second embodiments are described, and duplicate explanations may be omitted.

In a display device 1b of a HUD 100b according to the third embodiment, the second image display panel 20 is disposed tilted with respect to the X-Y plane perpendicular to the optical axis of the magnification optical system 2. The tilt angle of the second image display panel 20 with respect to the X-Y plane may be smaller than that of the first image display panel 10 with respect to the X-Y plane. Specifically, when the tilt angle of the first image display panel 10 with respect to the X-Y plane is about 40 degrees, for example, the tilt angle of the second image display panel 20 with respect to the X-Y plane is about 20 degrees, for example. As a result, sunlight entering from the optical axis direction of the magnification optical system 2 is reflected on the surface of the second image display panel 20 (the surface of the second polarizer 22) in a direction shifted from the optical axis of the magnification optical system 2. This makes it possible to prevent sunlight reflected on the surface of the second image display panel 20 (the surface of the second polarizer 22) from entering the eyes of the viewer OB.

### Modification

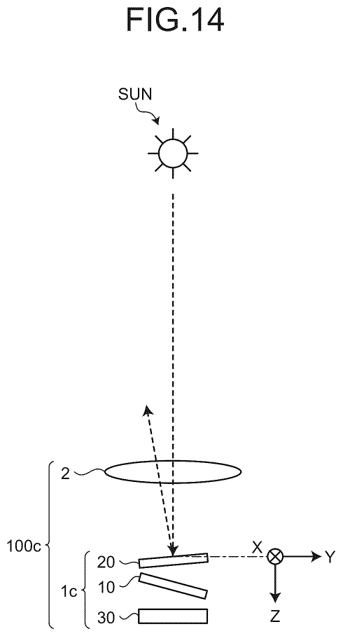

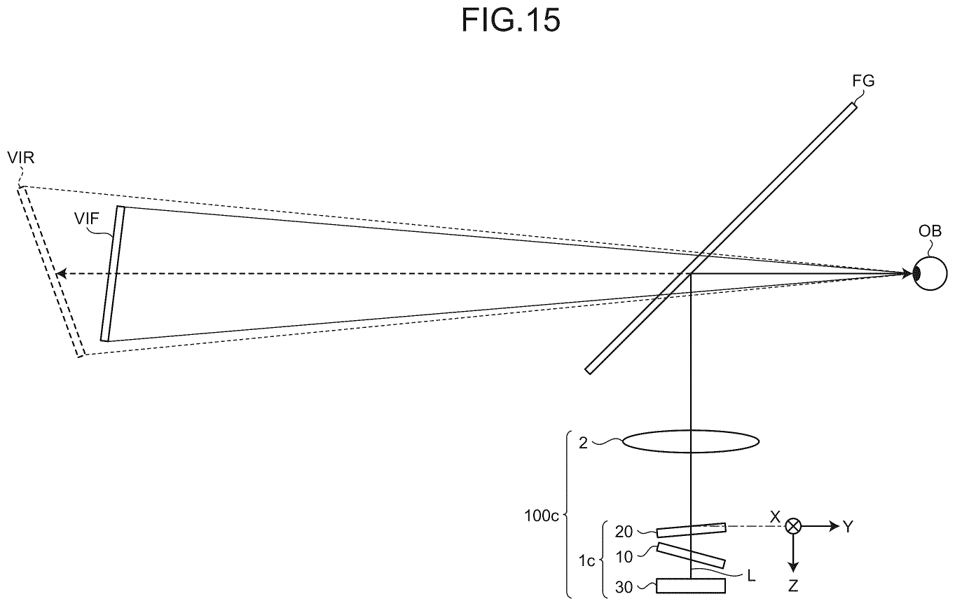

FIG. 14 is a schematic diagram illustrating the path of incoming sunlight in a HUD according to a modification of the third embodiment. FIG. 15 is a schematic diagram illustrating a schematic configuration of the HUD according to the modification of the third embodiment.

The direction of tilt of the second image display panel 20 is not limited to that illustrated in FIGS. 12 and 13. The direction of tilt may be that of a HUD 100c according to the modification of the third embodiment illustrated in FIGS. 14 and 15, for example. Specifically, the direction of tilt of the second image display panel 20 with respect to the X-Y plane may be the direction that is obtained by rotating the second image display panel 20 by 180 degrees in the X-Y plane with respect to the direction of tilt of the first image display panel 10 with respect to the X-Y plane. The present disclosure is not limited by the direction of tilt of the second image display panel 20.

### Fourth Embodiment

In the HUD in which the first image display panel 10 is disposed tilted with respect to the X-Y plane perpendicular to the optical axis of the magnification optical system 2 (e.g., the HUD 100a according to the second embodiment), when the backlight 30 is disposed substantially parallel to the X-Y plane perpendicular to the optical axis of the magnification optical system 2, the incident light to the first image display panel 10 may decrease, resulting in a reduction in contrast and luminance.

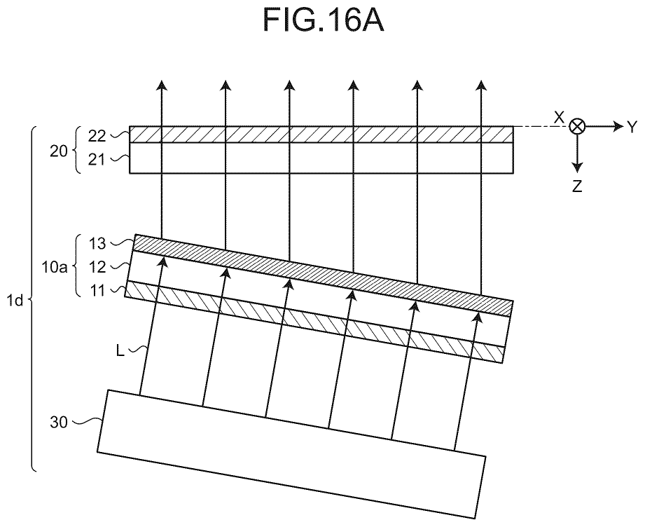

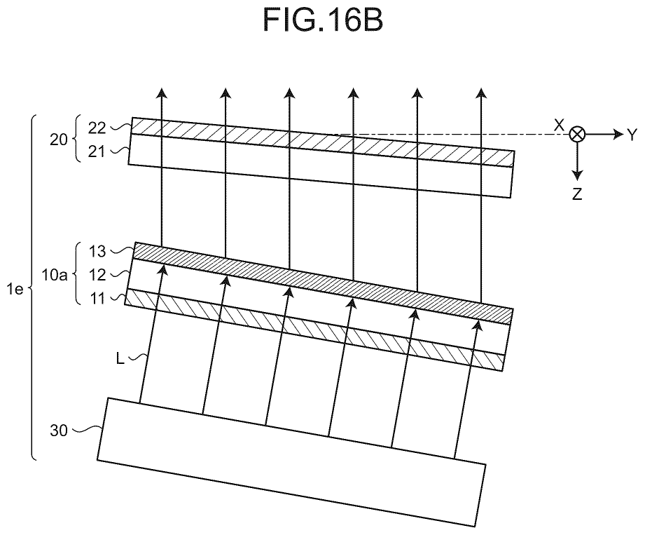

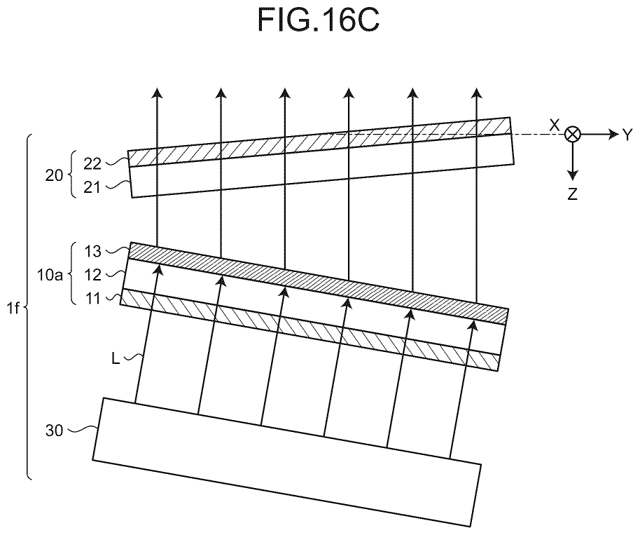

FIG. 16A is a schematic diagram illustrating a first example of the detailed configuration of a display device according to a fourth embodiment. FIG. 16B is a schematic diagram illustrating a second example of the detailed configuration of the display device according to the fourth embodiment. FIG. 16C is a schematic diagram illustrating a third example of the detailed configuration of the display device according to the fourth embodiment.

In display devices 1d, 1e, and 1f according to the fourth embodiment illustrated in FIGS. 16A, 16B, and 16C, the first image display panel 10a further includes a prism sheet 13 in addition to the first liquid crystal panel 11 and the first polarizer 12. In the display devices 1d, 1e, and 1f according to the fourth embodiment illustrated in FIGS. 16A, 16B, and 16C, the backlight 30 is disposed tilted with respect to the X-Y plane perpendicular to the optical axis of the magnification optical system 2. The tilt angle of the backlight 30 with respect to the X-Y plane is in a range of 20 degrees to 40 degrees, for example, the backlight 30 is more preferably disposed substantially parallel to the first image display panel 10a.

In the first example illustrated in FIG. 16A, the second image display panel 20 is disposed substantially parallel to the X-Y plane perpendicular to the optical axis of the magnification optical system 2, in the same manner as the display device 1a according to the second embodiment. In the second example illustrated in FIG. 16B, the second image display panel 20 is disposed tilted with respect to the X-Y plane perpendicular to the optical axis of the magnification optical system 2, in the same manner as the display device 1b according to the third embodiment. In the third example illustrated in FIG. 16C, the second image display panel 20 is disposed substantially parallel to the X-Y plane perpendicular to the optical axis of the magnification optical system 2, in the same manner as the display device 1c according to the modification of the third embodiment. In the display devices 1d, 1e, and 1f according to the fourth embodiment, the second image display panel 20 may be disposed substantially parallel to the X-Y plane perpendicular to the optical axis of the magnification optical system 2, as illustrated in FIG. 16A, or may be disposed tilted with respect to the X-Y plane perpendicular to the optical axis of the magnification optical system 2, as illustrated in FIGS. 16B and 16C.

In the display devices 1d, 1e, 1f according to the fourth embodiment described above, the prism sheet 13 refracts the light transmitted by the first image display panel such that the light is substantially parallel to the optical axis of the magnification optical system 2. This can prevent the reduction of light entering the first image display panel 10, thereby making it possible to improve contrast and luminance.

The preferred embodiments of the present disclosure are described above. The present disclosure is not limited to such embodiments. The contents disclosed in the embodiments are only examples and various modifications can be made without departing from the purpose of the present disclosure. For example, appropriate modifications made within the scope that does not depart from the purpose of the present disclosure naturally belong to the technical scope of the invention.

What is claimed is:

1. A head-up display that causes an image reflected by a light transmitting member that transmits and reflects incident light to be superimposed on a real image transmitted by the light transmitting member and causes the superimposed image to be visually recognized as a virtual image by a viewer, the head-up display comprising:
a display device that displays an image; and
a magnification optical system that magnifies the image displayed on the display device and projects the magnified image onto the light transmitting member, wherein
the display device includes:
a backlight;
a first image display panel that receives direct light from the backlight; and
a second image display panel that is disposed with a gap between the second image display panel and the first image display panel and receives light transmitted by the first image display panel,
the first image display panel includes a first polarizer provided between the first image display panel and the backlight,
the second image display panel includes a second polarizer provided between the second image display panel and the magnification optical system,
the first polarizer transmits light polarized in a first direction and blocks light polarized in a direction different from the first direction,
the second polarizer transmits light polarized in a second direction different from the first direction and blocks light polarized in a direction different from the second direction, and
no other polarizer is provided between the first image display panel and the second image display panel.

2. The head-up display according to claim 1, wherein an image output region of the first image display panel and an image output region of the second image display panel are superimposed on each other in an optical axis direction of the magnification optical system.

3. The head-up display according to claim 2, wherein a virtual distance from a viewpoint of the viewer to a virtual image of a first image displayed on the first image display panel is larger than a virtual distance from the viewpoint of the viewer to a virtual image of a second image displayed on the second image display panel.

4. The head-up display according to claim 3, wherein the virtual image of the first image and the virtual image of the second image are superimposed on each other in a sight line direction of the viewer.

5. The head-up display according to claim 4, wherein a first object in the virtual image of the first image and a second object in the virtual image of the second image are superimposed on each other in the sight line direction of the viewer to form a composite object.

6. The head-up display according to claim 5, wherein at least in one direction in a region in which the virtual image of the first image and the virtual image of the second image are superimposed on each other in the sight line direction of the viewer, as a gradation value of the first object increases, the gradation value of the second object decreases.

7. The head-up display according to claim 4, wherein the first image display panel is disposed so as to be tilted with respect to the second image display panel.

8. The head-up display according to claim 7, wherein the virtual image of the first image is tilted with respect to the virtual image of the second image.

9. The head-up display according to claim 8, wherein a virtual distance from the viewpoint of the viewer to an object disposed relatively in an upper part in the virtual image of the first image is larger than a virtual distance from the viewpoint of the viewer to an object disposed relatively in a lower part in the virtual image of the first image.

10. The head-up display according to claim 4, wherein the second image display panel is disposed so as to be tilted with respect to a plane perpendicular to the optical axis of the magnification optical system.

11. The head-up display according to claim 10, wherein the backlight is disposed so as to be tilted with respect to the plane perpendicular to the optical axis of the magnification optical system.

12. The head-up display according to claim 11, wherein the backlight is disposed substantially parallel to the first image display panel.

13. The head-up display according to claim 12, further comprising a prism sheet that is provided between the first image display panel and the second image display panel, wherein
the prism sheet refracts light transmitted by the first image display panel such that the light transmitted by the first image display panel is substantially parallel to the optical axis of the magnification optical system.
